(19) United States
(12) Patent Application Publication
(10) Pub. No.: US 2026/0365018 A1
(43) Pub. Date: Nov. 19, 2026

(54) VEHICLE IMAGING DEVICE

(71) Applicant: LG ELECTRONICS INC., Seoul (KR)

(72) Inventors: Ohjin KWEON, Seoul (KR); Kyoungil LEE, Seoul (KR)

(73) Assignee: LG ELECTRONICS INC., Seoul (KR)

(21) Appl. No.: 19/155,187

(22) PCT Filed: Feb. 1, 2024
(86) PCT No.: PCT/KR2024/001545

§ 371 Date: Aug. 8, 2025

(30) Foreign Application Priority Data
Feb. 10, 2023 (KR) 10-2023-0018023

(51) Int. Cl. B60K 35/23; G02B 27/01; G02B 27/09

(52) U.S. Cl. CPC B60K 35/23; G02B 27/0101; G02B 27/0149; G02B 27/0983; G02B 2027/0116; G02B 2027/015

(57) ABSTRACT

A vehicle imaging device comprises: a cover forming the exterior of a dash board of a vehicle; a picture generation unit (PGU) disposed in the upper area of the cover and forming light in a downward direction so that the light passes through the cover; and a mirror disposed inside the dash board and configured to reflect the light passing through the cover.

### TECHNICAL FIELD

This specification relates to a vehicle imaging device. One or more embodiments relate to a vehicle imaging device with a reduced volume.

### BACKGROUND ART

A vehicle is an apparatus that moves in a direction desired by a user riding therein. A representative example of a vehicle may be an automobile.

For convenience of a user using a vehicle, various types of sensors and electronic devices are arranged in the vehicle. In particular, for the convenience of the user's driving, research on an advanced driver assistance system (ADAS) is being actively carried out. In addition, an autonomous vehicle is actively under development.

In some embodiments, a vehicle display that shows various driving information related to a vehicle may be located below a driver's forward visual field for driving, which affects driving safety (rubbernecking). Therefore, a vehicle imaging device, such as a head-up display (HUD), may be mounted on a vehicle to enhance driving safety by projecting an image on a windshield at the front of the vehicle, positioned close to the driver's line of sight while driving.

### DISCLOSURE OF INVENTION

### Technical Problem

An aspect of the specification is to provide a vehicle imaging device which implements a picture generation unit (PGU)-separated structure and a volume is reduced.

Another aspect of the specification is to provide a vehicle imaging device having a picture generation unit (PGU)-separated structure, which is capable of securing optical performance while allowing volume reduction, by proposing a new optical structure to secure optical performance and avoid side effects.

Another aspect of the specification is to provide a structure in which a picture generation unit (PGU) is separately mounted to a ceiling, front glass, or A-pillar structure to enable volume reduction.

The tasks to be solved in the present disclosure may not be limited to the aforementioned, and other problems to be solved by the present disclosure will be obviously understood by a person skilled in the art based on the following description.

### Solution to Problem

According to one or more embodiments, a vehicle imaging device includes: a cover forming appearance of a dashboard of a vehicle; a picture generation unit (PGU) arranged in an upper region of the cover, and configured to emit light in a downward direction such that the light passes through the cover; and a mirror arranged inside the dashboard, and configured to reflect the light passing through the cover.

In an embodiment, a cross-section of the cover may be formed as a curve connecting a first point and a second point, and the second point may be arranged higher than the first point on a Z-axis. The mirror may be configured as a concave mirror with a cross-section which is formed as a curve connecting a third point and a fourth point.

In an embodiment, the first point may be arranged adjacent to a lower end portion on the windshield, and the second point may be arranged more adjacent to a driver's seat than to the lower end portion on the windshield. The third point may be arranged adjacent to the first point, and the fourth point, which is arranged adjacent to the driver's seat, may be arranged lower than the third point on the Z-axis.

In an embodiment, the PGU may include an emission region in which emission elements are arranged, and a first lens part arranged spaced apart from the emission elements in one axial direction. The PGU may further include a second lens part arranged spaced apart from the first lens part in the one axial direction. The PGU may further include a diffuser region arranged spaced apart from the second lens part in the one axial direction, to change a proceeding direction of the light passing through the first lens part and the second lens part The PGU may further include a display region arranged spaced apart from the diffuser region in the one axial direction, so that the light, which has changed in the proceeding direction by passing through the diffuser region, passes through the display region and forms an image.

In an embodiment, the first lens part may include first convex lenses formed convexly on one surface thereof facing the second lens part, and arranged on an XZ plane. The second lens part may include second convex lenses formed convexly on one surface thereof facing the first lens part, and arranged on the XZ plane.

In an embodiment, the second lens part may include a Fresnel pattern formed on another surface thereof and having a plurality of concave elliptical curved surfaces. A second height on a Y-axis of the second convex lenses may be lower than a first height on the Y-axis of the first convex lenses. A second diameter on an X-axis or Y-axis of each of the second convex lenses may be smaller than a first diameter on the Y-axis of each of the first convex lenses.

In an embodiment, the PGU may further include a reflection plane arranged between the second lens part and the diffuser region, and configured to reflect a first polarization component of the light. A second polarization component orthogonal to the first polarization component of the light transmitted through the reflection plane may pass through the display region.

In an embodiment, the reflection plane may include a reflective polarizing film configured to reflect the first polarization component of the light and a refractive film configured to refract the light passing through the first lens part and the second lens part to suppress light. The diffuser region may include a substrate and diffractive optical elements (DOE) arranged on one surface of the substrate. A proceeding direction of the light passing through the DOEs may be formed at a certain tilt angle in a downward direction with respect to a horizontal plane.

In an embodiment, the display region may be arranged at a first tilt angle smaller than 90 degrees with respect to a horizontal plane. The vehicle imaging device may further include: a first mirror arranged above the PGU with being spaced apart from the PGU, and configured to reflect the light from the PGU and transmit sunlight; and a cover glass arranged at a second tilt angle greater than 90 degrees to allow the light reflected from the first mirror to pass therethrough.

In an embodiment, a first point of the first mirror may be arranged adjacent to a third point on an upper end of the cover glass, and a second point of the first mirror may be arranged adjacent to a fourth point on an upper end of the display region. The light generated in the PGU may be reflected from the first mirror, pass through the cover glass, be reflected from the mirror, pass through the cover, and be reflected from the windshield, so as to be displayed as image information to a user inside the vehicle.

In an embodiment, upper and lower end portions of the diffuser region may form a first point and a second point. Upper and lower end portions of the display region may form a third point and a fourth point. The diffuser region may be arranged at a tilt angle of 90 degrees. The display region may be arranged at a first tilt angle smaller than 90 degrees, so that a second distance between the second point and the fourth point is longer than a first distance between the first point and the third point.

In an embodiment, the first mirror may include a polarizing film arranged on a front surface thereof and having patterns formed in a specific axial direction to transmit first polarization signals of the sunlight and ultraviolet rays and reflect a second polarization signal of the light generated in the PGU.

In an embodiment, the vehicle imaging device may further include photo sensors arranged spaced apart from the first mirror above the first mirror on a Z-axis; and a motor coupled to the first mirror to tilt the first mirror in the Z-axis direction at an angle in a certain range. The photo sensors may be arranged at different points to detect the sunlight and ultraviolet rays transmitted through the first mirror and absorb first polarization signals of the sunlight and the ultraviolet rays. A refraction angle of the light passing through the diffuser region may be changed as the first mirror is tilted by the motor, so that the user's eyebox region is adjusted on the Z-axis.

In an embodiment, the display region may be arranged at a second tilt angle greater than 90 degrees with respect to a horizontal plane. The vehicle imaging device may further include a second mirror arranged adjacent to the display region and configured to transmit the light from the PGU and reflect sunlight. The second mirror on which the second polarizing film is arranged may form a cover glass. The light generated in the PGU may pass through the second mirror and the cover glass, may be reflected from the mirror, may pass through the cover again, and may be reflected from the windshield, so as to be displayed as image information to a user inside the vehicle.

In an embodiment, the second mirror may include a second polarizing film arranged on one surface thereof and having second patterns formed in a specific axial direction to reflect first polarization signals of the sunlight and ultraviolet rays and transmit a second polarization signal of the light generated in the PGU.

In an embodiment, upper and lower end portions of the diffuser region may form a first point and a second point. Upper and lower end portions of the display region may form a third point and a fourth point. The diffuser region may be arranged at a first tilt angle greater than 90 degrees. The display region may be arranged at a second tilt angle greater than the first tilt angle. The display region may be arranged at the second tilt angle greater than the first tilt angle, so that a second distance between the second point and the fourth point is shorter than a first distance between the first point and the third point.

In an embodiment, the vehicle imaging device may further include a second motor coupled to the second lens part to move the second lens part in the Z-axis direction. A refraction angle of the light passing through the diffuser region may be changed as the second lens part is moved by the second motor, so that the user's eyebox region is adjusted on the Z-axis.

In an embodiment, the PGU may be arranged as a plurality of PGUs in a roof region inside the vehicle, coupled to the windshield above the windshield. The PGUs may include a first PGU, a second PGU, and a third PGU spaced apart in a horizontal axis direction in the roof region. The first PGU, the second PGU, and the third PGU may form a first light-forming region, a second light-forming region, and a third light-forming region, respectively, and The second light-forming region may be formed in a certain angular range with respect to 0 degree, the first light-forming region may be formed in a right direction toward the second light-forming region, and the third light-forming region may be formed in a left direction toward the second light-forming region.

In an embodiment, the PGU may be arranged as a plurality of PGUs in an upper region of the windshield. The PGUs may include a first PGU, a second PGU, and a third PGU spaced apart in a horizontal axis direction in the upper region of the windshield. The first PGU, the second PGU, and the third PGU may form a first light-forming region, a second light-forming region, and a third light-forming region, respectively. The second light-forming region may be formed in a certain angular range with respect to 0 degree, the first light-forming region may be formed in a right direction toward the second light-forming region, and the third light-forming region may be formed in a left direction toward the second light-forming region.

In an embodiment, the PGU may further include a fourth PGU arranged in a pillar region inside the vehicle, coupled to the windshield on one side of the windshield. A fourth light-forming region of the fourth PGU may be formed in a right direction toward the second light-forming region. A second tilt angle at which the fourth light-forming region is formed may be greater than a first tilt angle at which the first light-forming region is tilted.

Details of other embodiments are included in the detailed description and drawings.

### Advantageous Effects of Invention

The technical features of a personalized infotainment device for a vehicle according to the specification may be summarized as follows.

According to the specification, a vehicle imaging device may be provided in which a picture generation unit (PGU)-separated structure is implemented and a volume of the vehicle imaging device is reduced by arranging the PGU in a separated upper region in a vehicle, other than an inner region of a dashboard.

According to the specification, a limited space issue of the dashboard may be resolved by arranging only a concave mirror in the inner region of the dashboard and arranging the PGU in the separate upper region inside the vehicle, other than the inner region of the dashboard.

According to the specification, a reflection effect and optical performance degradation, which may be caused by a cover of the dashboard due to the arrangement of the PGU in the separated region, may be overcome.

According to the specification, a diffuser region in which a special optical element, namely, a diffractive optical element (DOE), is arranged inside the PGU 1100 may be formed to overcome the reflection effect and optical performance degradation caused by the cover of the dashboard.

According to the specification, a polarizing film and a refractive film may be arranged on a reflection plane inside the PGU so as to overcome the reflection effect and optical performance degradation caused by the cover of the dashboard.

According to the specification, a holographic structure may be formed on another surface of a structure in which lens elements are arranged inside the PGU, thereby overcoming the reflection effect and optical performance degradation caused by the cover of the dashboard.

According to the specification, a vehicle imaging device having a PGU-separated structure may be provided to secure optical performance while allowing volume reduction, by proposing a new optical structure which is capable of securing optical performance and avoiding side effects.

According to the specification, a structure may be provided, in which the PGU is separately mounted to a ceiling, windshield, or A-pillar structure to enable volume reduction.

The effects of the disclosure are not limited to those effects mentioned above, and other effects not mentioned may be clearly understood by those skilled in the art from the description of the appended claims.

### BRIEF DESCRIPTION OF DRAWINGS

FIG. 1 is a view illustrating appearance of a vehicle according to an embodiment.

FIG. 2 is a diagram of the appearance of the vehicle at various angles.

FIGS. 3 and 4 are diagrams of the interior of a vehicle according to an embodiment.

FIG. 5 is a block diagram of a vehicle according to an embodiment.

FIG. 6A is a view of a configuration in which a screen of a certain ratio is formed in a specific region of front glass of a vehicle.

FIG. 6B is a view of a structure in which a vehicle imaging device for creating the screen of the certain ratio of FIG. 6A is arranged inside a dashboard of the vehicle.

FIG. 7A is a view of a picture generation unit (PGU) arranged in a lower region of a cover.

FIG. 7B is a view of the PGU arranged in an upper region of the cover.

FIG. 8 is a view of the internal structure of the PGU of the vehicle imaging device shown in FIG. 7B.

FIGS. 9 to 11 are diagrams of a plurality of components constituting the PGU of FIG. 8.

FIG. 12 is a view of a first structure of a vehicle imaging device in which a first mirror is arranged substantially horizontally between a display region and cover glass.

FIG. 13 is a diagram showing that a reflection angle is adjusted and an eyebox region is changed as the first mirror is tilted in the first structure of FIG. 12.

FIG. 14 is a diagram of a second structure of a vehicle imaging device in which a second mirror is arranged substantially parallel to the front of a display region.

FIG. 15 is a diagram showing that a reflection angle is adjusted and an eyebox region is changed as the second mirror is tilted in the second structure of FIG. 14.

FIGS. 16 to 19 are diagrams of vehicle arrangement structures each having at least one PGU at various locations in the vehicle according to embodiments.

FIG. 20 is a block diagram of a vehicle having a vehicle imaging device according to the specification.

### MODE FOR THE INVENTION

Description will now be given in detail according to one or more embodiments disclosed herein, with reference to the accompanying drawings. For the sake of brief description with reference to the drawings, the same or equivalent components may be provided with the same or similar reference numbers, and description thereof will not be repeated. The terms “module” and “unit” as used herein interchangeably or individually used to refer to a constituent element only for convenience in description in the specification and therefore are not themselves intended to take on different meanings or to depict different functions. In describing one or more embodiments disclosed herein, a detailed description of a related well-known technology will be omitted when it is determined that it would obscure the gist of the disclosure. The accompanying drawings are used to help easily understand the technical idea of the disclosure and it should be understood that the idea of the disclosure is not limited by the accompanying drawings. The idea of the disclosure should be construed to extend to any alterations, equivalents and substitutes besides the accompanying drawings.

It will be understood that although the terms first, second, etc. may be used herein to describe various elements, these elements should not be limited by these terms. These terms are generally only used to distinguish one element from another.

It will be understood that when a component is referred to as being “connected to” or “coupled to” another component, it may be directly connected to or coupled to another component or intervening components may be present. In contrast, when an element is referred to as being “directly connected with” another element, there are no intervening elements present.

The singular forms are intended to include the plural forms as well, unless the context clearly indicates otherwise.

The term “include” or “has” as used herein should be understood that it is intended to indicate the existence of a feature, a number, a step, an element, a component, or a combination thereof disclosed in the specification, and it may also be understood that the existence or additional possibility of one or more other features, numbers, steps, elements, components, or combinations thereof are not excluded in advance.

A vehicle according to an embodiment of the present disclosure may be understood as a conception including automobiles, motorcycles, and the like. Hereinafter, the vehicle will be described based on a car.

The vehicle according to the embodiment of the present disclosure may be a conception including all of an internal combustion engine car having an engine as a power source, a hybrid vehicle having an engine and an electric motor as power sources, an electric vehicle having an electric motor as a power source, and the like.

In the following description, a left side of a vehicle refers to a left side in a driving direction of the vehicle, and a right side of the vehicle refers to a right side in the driving direction.

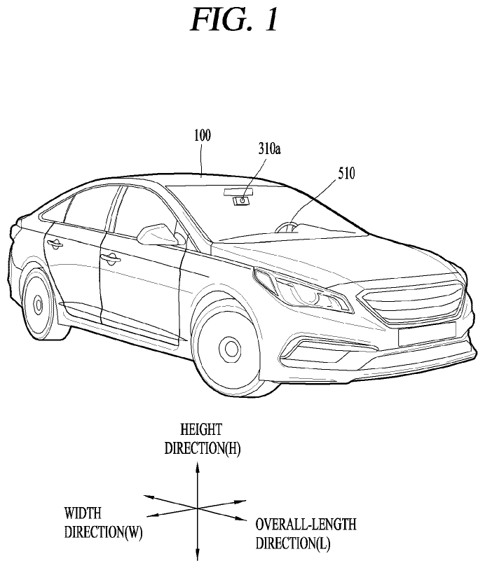

FIG. 1 is a view illustrating appearance of a vehicle according to an embodiment.

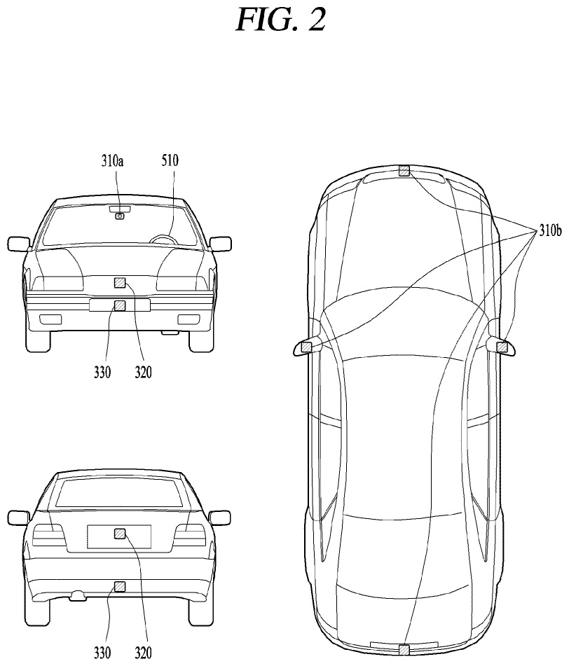

FIG. 2 is a diagram illustrating the appearance of the vehicle at various angles.

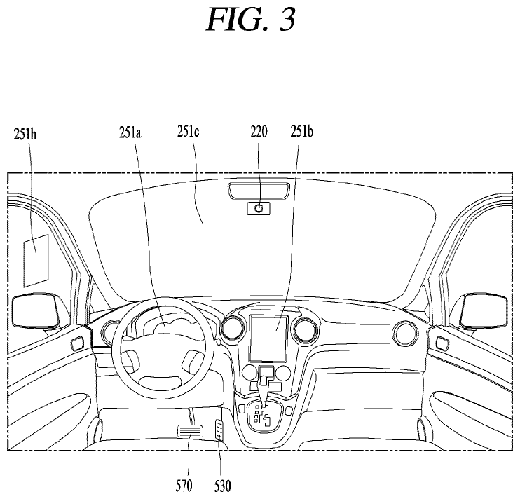

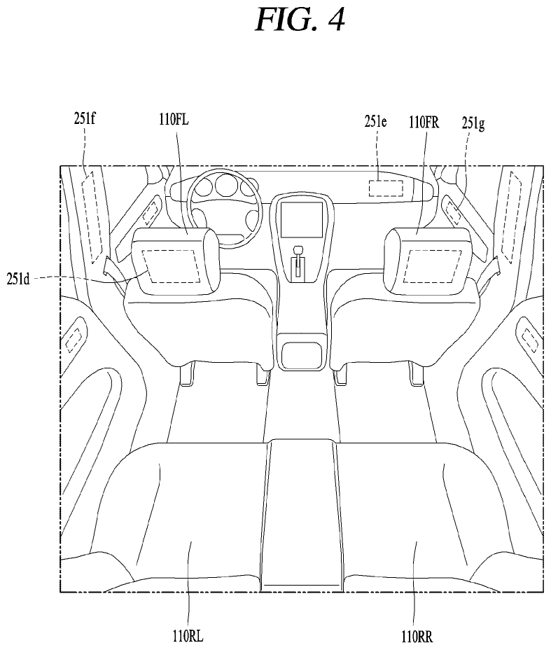

FIGS. 3 and 4 are diagrams of the interior of a vehicle according to an embodiment.

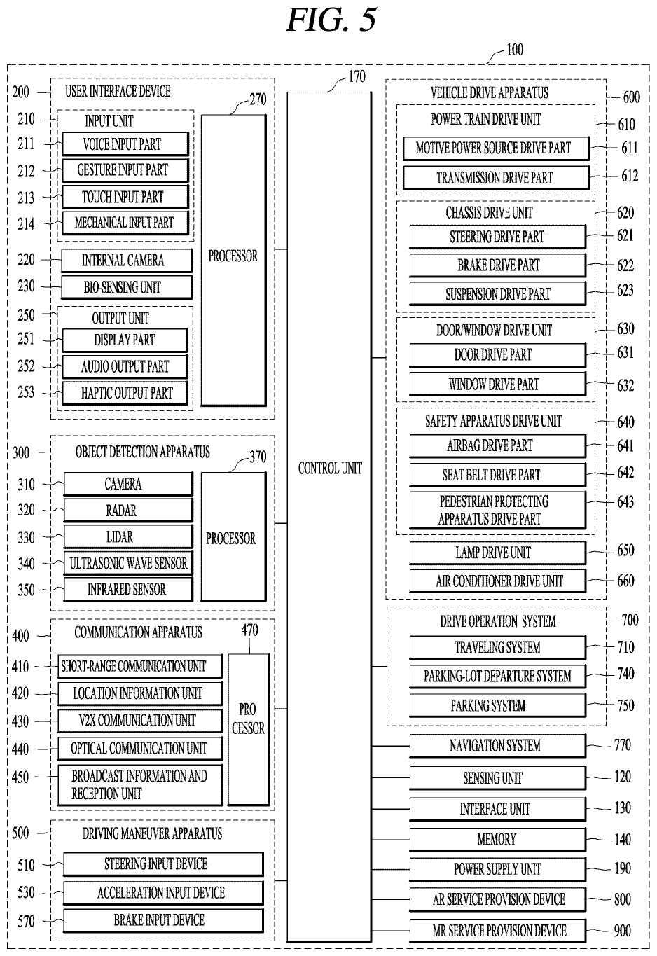

FIG. 5 is a block diagram of a vehicle according to an embodiment.

As illustrated in FIGS. 1 to 5, a vehicle 100 may include wheels rotating by a power source, and a steering input apparatus 510 for adjusting a driving (ongoing, moving) direction of the vehicle 100.

The vehicle 100 may be an autonomous vehicle.

The vehicle 100 may be switched into an autonomous mode or a manual mode based on a user input.

For example, the vehicle 100 may be converted from the manual mode into the autonomous mode or from the autonomous mode into the manual mode based on a user input received through a user interface device 200.

The vehicle 100 may be switched into the autonomous mode or the manual mode based on traveling situation information. The traveling situation information may be generated based on object information provided from an object detection device 300.

For example, the vehicle 100 may be switched from the manual mode into the autonomous mode or from the autonomous module into the manual mode based on traveling situation information generated in the object detection device 300.

In an example, the vehicle 100 may be switched from the manual mode into the autonomous mode or from the autonomous mode into the manual mode based on traveling situation information received through a communication device 400.

The vehicle 100 may switch from the manual mode into the autonomous mode or from the autonomous module into the manual mode based on information, data, or signal provided by an external device.

When the vehicle 100 is driven in the autonomous mode, the vehicle 100 may be driven based on a driving system 700.

For example, the autonomous vehicle 100 may be driven based on information, data, or signals that are generated by a traveling system 710, a parking-lot departure system 740, and a parking system 750.

When the vehicle 100 is driven in the manual mode, the autonomous vehicle 100 may receive a user input for driving through a driving operation device 500. The vehicle 100 may be driven based on the user input received through the driving operation device 500.

An overall length refers to a length from a front end to a rear end of the vehicle 100, a width refers to a width of the vehicle 100, and a height refers to a length from a bottom of a wheel to a roof. In the following description, an overall-length direction L may refer to a direction which serves as a reference for measuring the overall length of the vehicle 100, a width direction W may refer to a direction that serves as a reference for measuring the width of the vehicle 100, and a height direction H may refer to a direction that serves as a reference for measuring the height of the vehicle 100.

As illustrated in FIG. 5, the vehicle 100 may include a user interface device 200, an object detection device 300, a communication device 400, a driving operation device 500, a vehicle drive device 600, a driving system 700, a navigation system 770, a sensing unit 120, an interface unit 130, a memory 140, a controller 170, and a power supply unit 190.

According to embodiments the vehicle 100 may include more components in addition to components described herein or may not include some of those components described herein.

The user interface device 200 may be a device for communication between the vehicle 100 and a user. The user interface device 200 may receive a user input and provide information generated in the vehicle 100 to the user. The vehicle 100 may implement user interfaces (UIs) or user experiences (UXs) through the user interface device 200.

The user interface device 200 may include an input unit 210, an internal camera 220, a biometric sensing unit 230, an output unit 250 and a processor 270.

In some embodiments, the user interface device 200 may include more components in addition to components to be explained in this specification or may not include some of those components to be explained in this specification.

The input unit 200 may allow the user to input information. Data collected in the input unit 120 may be analyzed by the processor 270 and processed as a user's control command.

The input unit 200 may be disposed inside the vehicle. For example, the input unit 200 may be disposed on one region of a steering wheel, one region of an instrument panel, one region of a seat, one region of each pillar, one region of a door, one region of a center console, one region of a headlining, one region of a sun visor, one region of a windshield, one region of a window, or the like.

The input unit 200 may include a voice input part 211, a gesture input part 212, a touch input part 213, and a mechanical input part 214.

The voice input part 211 may convert a user's voice input into an electric signal. The converted electric signal may be provided to the processor 270 or the controller 170.

The voice input part 211 may include at least one microphone.

The gesture input part 212 may convert a user's gesture input into an electric signal. The converted electric signal may be provided to the processor 270 or the controller 170.

The gesture input part 212 may include at least one of an infrared sensor and an image sensor for detecting the user's gesture input.

According to embodiments, the gesture input part 212 may detect a user's three-dimensional (3D) gesture input. To this end, the gesture input part 212 may include a light emitting diode emitting a plurality of infrared rays, or a plurality of image sensors.

The gesture input part 212 may detect the user's 3D gesture input by a time of flight (TOF) method, a structured light method or a disparity method.

The touch input part 213 may convert the user's touch input into an electric signal. The converted electric signal may be provided to the processor 270 or the controller 170.

The touch input part 213 may include a touch sensor for detecting the user's touch input.

According to an embodiment, the touch input part 213 may be integrated with the display 251 so as to implement a touch screen. The touch screen may provide an input interface and an output interface between the vehicle 100 and the user.

The mechanical input part 214 may include at least one of a button, a dome switch, a jog wheel, and a jog switch. An electric signal generated by the mechanical input part 214 may be provided to the processor 270 or the controller 170.

The mechanical input part 214 may be arranged on a steering wheel, a center fascia, a center console, a cockpit module, a door, and the like.

The internal camera 220 may acquire an internal image of the vehicle. The processor 270 may detect a user's status from the image of the interior of the vehicle. The processor 270 may acquire information related to the user's gaze from the image of the interior of the vehicle. The processor 270 may detect the user's gesture from the image of the interior of the vehicle.

The biometric detection unit 230 may acquire the user's biometric information. The biometric detection unit 230 may include a sensor for detecting the user's biometric information and acquire fingerprint information and heart rate information regarding the user using the sensor. The biometric information may be used for user authentication.

The output unit 250 may generate an output related to a visual, auditory or tactile signal.

The output unit 250 may include at least one of a display 251, an audio output part 252, and a haptic output part 253.

The display 251 may output graphic objects corresponding to various types of information.

The display 251 may include at least one of a liquid crystal display (LCD), a thin film transistor-liquid crystal display (TFT-LCD), an organic light-emitting diode (OLED), a flexible display, a 3-dimensional (3D) display, and an e-ink display.

The display 251 may be inter-layered or integrated with a touch input part 213 to implement a touch screen.

The display 251 may be implemented as a head up display (HUD), a center information display (CID), a cluster, and/or a rear seat entertainment (RSE). When the display 251 is implemented as the HUD, the display 251 may be provided with a projection module and thus output information through an image which is projected onto a windshield or a window.

The display 251 may include a transparent display. The transparent display may be attached to the windshield or the window.

The transparent display may have a predetermined degree of transparency and output a predetermined screen thereon. The transparent display may include at least one of a thin film electroluminescent (TFEL), a transparent organic light-emitting diode (OLED), a transparent liquid crystal display (LCD), a transmissive transparent display, or a transparent LED display. The transparent display may have adjustable transparency.

In some examples, the user interface device 200 may include a plurality of display modules 251a to 251g.

The display 251 may be disposed on one region of the steering wheel, one region 251a, 251b, 251e of the instrument panel, one region 251d of the seat, one region 251f of each pillar, one region 251g of the door, one region of the center console, one region of the headlining, or one region of the sun visor, or implemented on one region 251c of the windshield or one region 251h of the window.

Driving-related information for a driver may be displayed in one region 251a, 251b of the instrument panel. A personal infotainment display may be implemented in one region 251e of the instrument panel by a vehicle imaging device for a passenger seated in a front passenger seat. A personal infotainment display may be implemented in one region 251d of the seat by a vehicle imaging device for rear seat entertainment (RSE).

The audio output part 252 may convert an electric signal provided by the processor 270 or the controller 170 into an audio signal and output the audio signal. To this end, the audio output part 252 may include at least one speaker.

The haptic output part 253 may generate a tactile output. For example, the haptic output part 253 may oscillate the steering wheel, a safety belt, a seat 110FL, 110FR, 110RL, 110RR such that the user may recognize such output.

The processor 270 may control an overall operation of each unit of the user interface device 200.

According to an embodiment, the user interface device 200 may include a plurality of processors 270 or may not include any processor 270.

When the processor 270 is not included in the user interface device 200, the user interface device 200 may operate according to a control of a processor of another device within the vehicle 100 or the controller 170.

In some embodiments, the user interface device 200 may be named a display device for vehicle.

The user interface device 200 may operate under the control of the controller 170.

The object detection device 300 is a device for detecting an object located outside the vehicle 100.

Examples of the object may include a variety of objects associated with driving (operation) of the vehicle 100.

In some embodiments, a vehicle imaging device according to this specification will be described. In some embodiments, a vehicle display that shows various driving information related to a vehicle may be located below a driver's forward visual field for driving, which affects driving safety (rubbernecking). Therefore, a vehicle imaging device, such as a head-up display (HUD), may be mounted on a vehicle to enhance driving safety by projecting an image on a windshield at the front of the vehicle, positioned close to the driver's line of sight while driving.

An infotainment device also needs to be installed in a passenger or rear seat of the vehicle to provide personal information and personal entertainment content. Therefore, there is a need for a vehicle imaging device that is capable of displaying driving-related information in a front region of a driver's seat of the vehicle or provide personal entertainment content in a front region of a passenger or rear seat of the vehicle.

To display such driving-related information or entertainment content in a specific region of the windshield at the front of the vehicle, the vehicle imaging device may need to have a large aspect ratio in which a width in one direction is a certain percentage greater than a length in another direction. However, there is a problem in that any position and any structure to provide the vehicle imaging device for constituting a screen with a large aspect ratio in the vehicle are not mentioned.

To solve these problems, an aspect of this specification is to provide a vehicle imaging device having a large aspect ratio using a projection optical system related to the vehicle. Another aspect of this specification is to display driving-related information on a screen having a large aspect ratio in a specific region of the windshield at the front of the vehicle. Still another aspect of this specification is to provide a vehicle imaging device having an optical structure and a special screen for allowing an image to have a large aspect ratio by using a single image module. Still another aspect of this specification is to implement continuous images related to driving-related information to have a large aspect ratio by using a single image module. Still another aspect of this specification is to provide a small and thin vehicle imaging device.

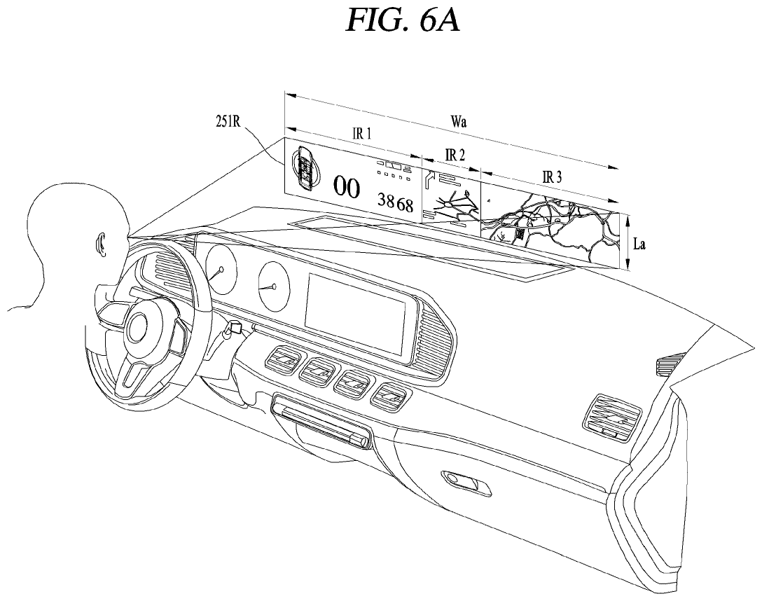

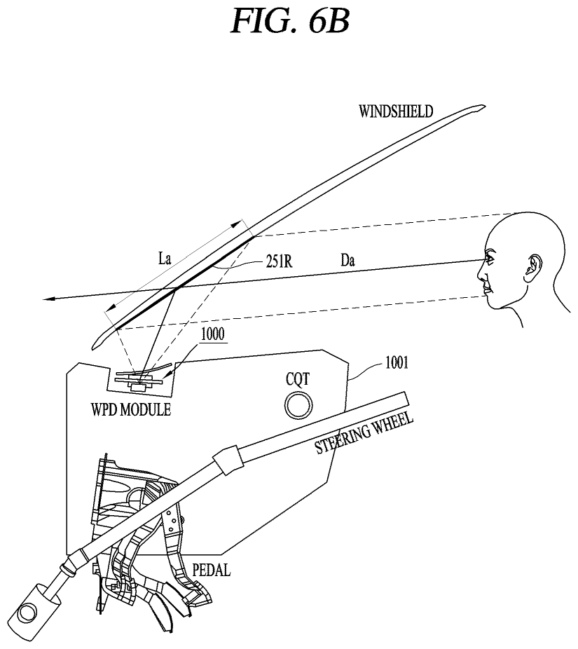

Hereinafter, a vehicle imaging device for achieving the aforementioned purposes will be described in detail with reference to the drawings. In this regard, FIG. 6A is a view of a configuration in which a screen of a certain ratio is formed in a specific region of front glass of a vehicle. FIG. 6B is a view of a structure in which a vehicle imaging device for creating the screen of the certain ratio of FIG. 6A is arranged inside a dashboard of the vehicle.

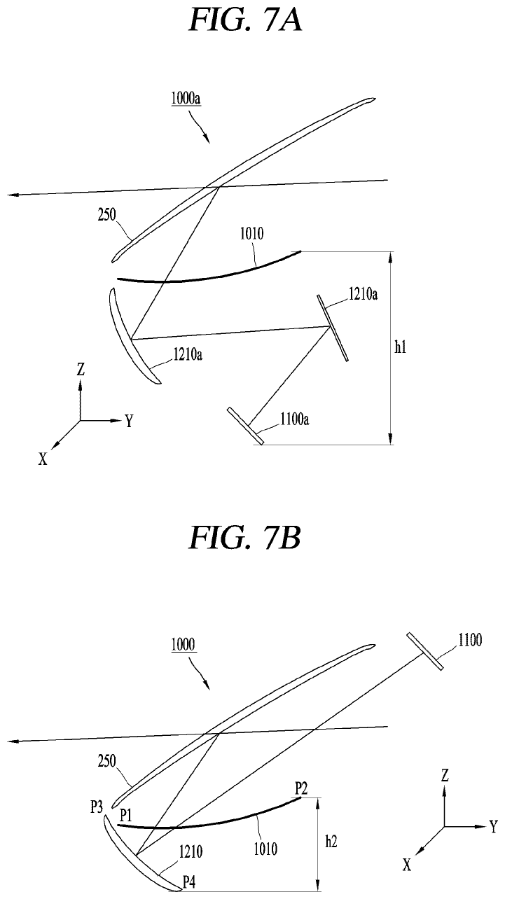

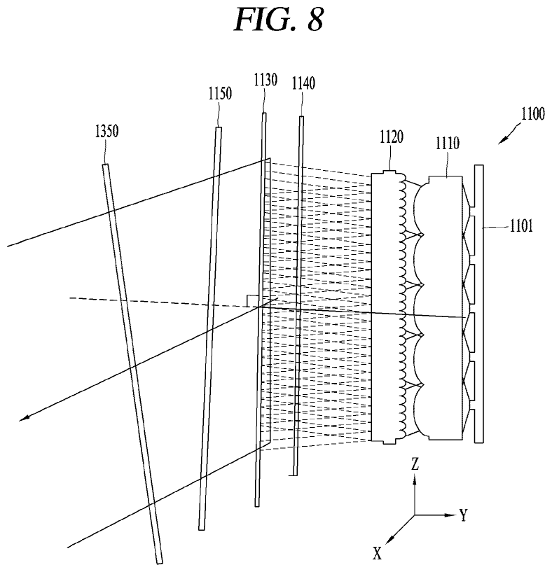

In some embodiments, FIG. 7 is a view of a structure in which a picture generation unit and internal components of the vehicle imaging device of FIG. 6B are arranged inside a cover. FIG. 8A is a view of a structure in which the picture generation unit is arranged on a left side of a screen panel in the vehicle imaging device of FIG. 7. FIG. 8B is a view of a structure in which the picture generation unit is arranged on a right side of the screen panel in the vehicle imaging device of FIG. 7.

Referring to FIG. 6A, an image having a width Wa in one axial direction and a length La in another axial direction may be displayed in a specific region 251R of a windshield of a vehicle. The image may be configured to include a plurality of image regions displaying information necessary for driving the vehicle. The plurality of image regions may include a first image region IR1 to a third image region IR3. A first image including vehicle-related information may be displayed in the first image region IR1 closest to a driver's field of view (FOV) range in the vehicle. A second image associated with a vehicle driving path may be displayed in the second image region IR2. A third image associated with a map including an origin and a destination may be displayed in the third image region IR3. As the plurality of images are displayed in the specific region 251R, the width Wa in the one axial direction may be set to be longer than the length La in the another axial direction by a certain ratio, for example, at least 5 times.

Referring to FIGS. 6A and 6B, a vehicle imaging device 1000 may be arranged inside the dashboard of the vehicle. The vehicle imaging device 1000 may be arranged in a specific region inside the dashboard not to overlap a region where a steering wheel and pedals are arranged. An image by light, which is reflected from a screen panel 1200 constituting the vehicle imaging device 1000, may be displayed in the specific region 251R of the windshield of the vehicle. The specific region 251R may be implemented with a certain length La so that the image is displayed in the driver's FOV range. A distance from a center of the driver's gaze to a center of the specific region 251R may be determined as a certain distance, for example, approximately 1.2 m.

In some embodiments, a vehicle imaging device according to the specification will be described. The overall height may be adjusted by changing the arrangement structure of a picture generation unit PGU. In this regard, FIG. 7A is a view of a picture generation unit (PGU) arranged in a lower region of a cover. FIG. 7B is a view of the PGU arranged in an upper region of the cover.

Referring to FIG. 7A, a vehicle imaging device 1000a may include a cover 1010, a PGU 1100a, a concave mirror 1210a, and a flat mirror 1220. Light emitted from the vehicle imaging device 1100a may be reflected from the flat mirror 1220 and the concave mirror 1210a and pass through the cover 1010. Light passing through the cover 1010 may be reflected from the windshield 250 and may proceed to the user's eyebox region. As the PGU 1100a is arranged at the lowermost end of the vehicle imaging device 1000a, a height h1 of the lower region of the vehicle imaging device 1000a on the Z axis, which corresponds to a distance from a lower end of the PGU 1100a to the cover 1010, may increase. The height h1 on the Z axis of the lower region of the vehicle imaging device 1000a may correspond to a height of a dashboard on which the vehicle imaging device 1000a is arranged.

Referring to FIG. 7B, a vehicle imaging device 1000 may include a cover 1010, a PGU 1100, a concave mirror 1210. Light emitted from the vehicle imaging device 1100a may pass through the cover 1010, may be reflected from the concave mirror 1010, and pass through the cover 1010 again. Light which has passed through the cover 1010 again may be reflected from the windshield 250 and proceed to the user's eyebox region. As the PGU 1100 is arranged in the upper region of the cover 1010 of the vehicle imaging device 1000a, a height h2 of the lower region of the vehicle imaging device 1000 on the Z axis, which corresponds to a distance from the lower end of the concave mirror 1210 to the cover 1010, may decrease. The height h1 on the Z axis of the lower region of the vehicle imaging device 1000a may correspond to a height of a dashboard on which the vehicle imaging device 1000a is arranged.

In some embodiments, a tilt angle of the concave mirror 1210 of FIG. 7B may be formed in a horizontal direction compared to a tilt angle of the concave mirror 1210a of FIG. 7A, such that the height h2 of the lower region of the vehicle imaging device 1000 may decrease. Accordingly, the height h2 of the lower region of the vehicle imaging device 1000 of FIG. 7B on the Z axis may decrease compared to the height h1 of the lower region of the vehicle imaging device 1000a of FIG. 7A on the Z axis.

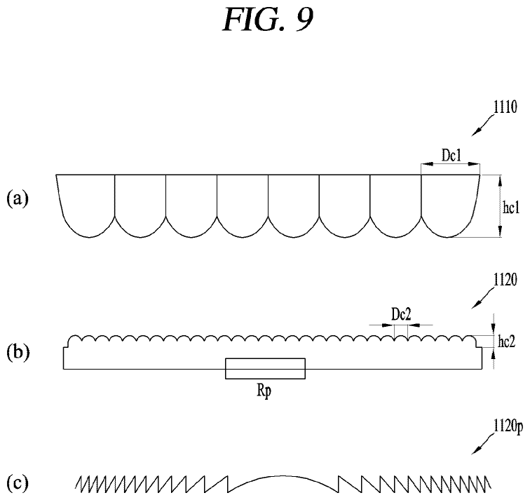

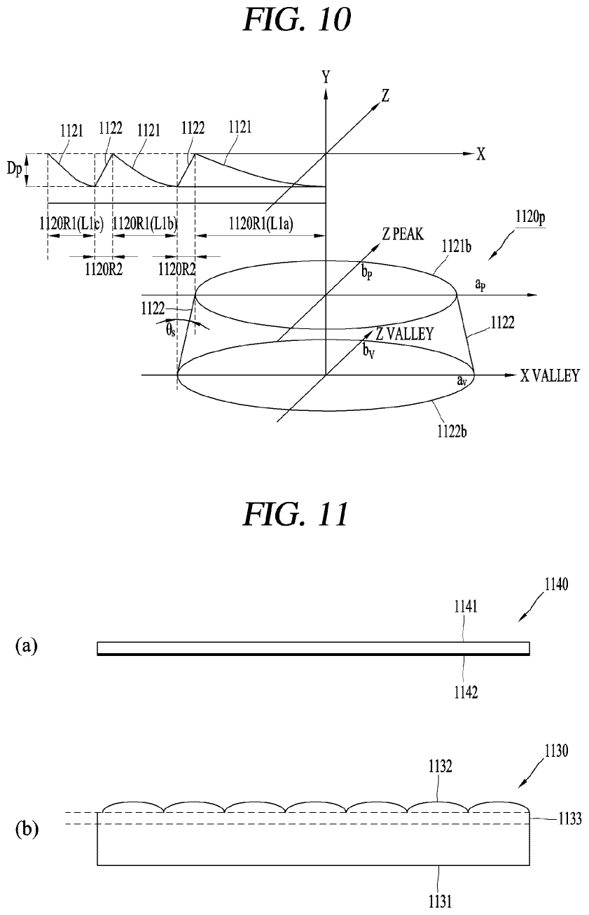

In some embodiments, FIG. 8 is a view of the internal structure of the PGU of the vehicle imaging device shown in FIG. 7B. FIGS. 9 to 11 are diagrams of a plurality of components constituting the PGU of FIG. 8. (a) of FIG. 9 is an enlarged cross-sectional view of a first lens part 1110 of FIG. 8. (b) of FIG. 9 is an enlarged cross-sectional view of a second lens part 1120 of FIG. 8. (c) of FIG. 9 is a cross-sectional view of a Fresnel pattern on another surface of the second lens part 1120 shown in FIG. 8 and (b) of FIG. 9. In this regard, FIG. 10 is an enlarged view of the Fresnel pattern on the another surface of the second lens part 1120 of FIG. 8 and (b) of FIG. 9, and is an enlarged view of a partial region Rp on the another surface of the second lens part 1120.

(a) of FIG. 11 is a cross-sectional view of a reflection plane 1140 arranged between the second lens part 1120 and a diffuser region 1130 of FIG. 8. (b) of FIG. 11 is a cross-sectional view of the diffuser region 1130 arranged between the reflection plane 1140 of FIG. 8 and a display region 1150.

Hereinafter, a vehicle imaging device according to the specification will be described with reference to FIG. 6B, and 7B to 11. The vehicle imaging device 1000 may include a cover 1010, a PGU 1100, and a mirror 1210.

In this regard, the vehicle imaging device 1000 implemented as a head mounted display (HUD) may be mounted in a dashboard 1001 of a vehicle and must avoid interferences with other components, such as a steering device. Therefore, the vehicle imaging device 1000 may have a limitation in having to reduce a size. To avoid the limitation, securing optical performance while minimizing the height of the lower region of the vehicle imaging device 1000 may be one of the important issues.

The specification proposes a structure in which a picture generation unit (PGU) is separated (or detached) and mounted to a ceiling, windshield, or A-pillar structure, to enable volume reduction. By proposing a new optical structure that may secure optical performance and avoid side effects, optical performance may be secured and simultaneously volume reduction may be allowed.

The cover 1010 may form the appearance of the dashboard 1001 of the vehicle. The PGU 1100 may include various projectors and a display which displays pixels on a screen. Image rays emitted by the PGU 1100 may be output as linearly polarized signals.

The PGU 1100 may be arranged in the upper region of the cover 1010 in the Z-axis direction. The PGU 1100 may emit light downward so that the light passes through the cover 1010. The mirror 1210 may be arranged in the cover 1010 which defines the appearance of the dashboard 1001. The mirror 1210 may be configured to reflect the light which has passed through the cover 1010.

The cover 1010 may have a cross-section which is formed as a curve connecting a first point P1 and a second point P2. The second point P2 of the cover 1010 may be arranged to be higher than the first point P1 on the Z axis. The mirror 1210 may be configured as a concave mirror 1210 whose cross-section is formed as a curve connecting a third point P3 and a fourth point P4.

The first point P1 of the cover 1010 may be arranged adjacent to a lower end portion of the windshield 250. The second point P2 of the cover 1010 may be arranged more adjacent to a driver's seat than the lower end portion of the windshield 250. The mirror 1210 may be arranged such that the third point P3 is more adjacent to the first point P1 of the cover 1010 than to the second point P2. As the third point P3 of the mirror 1210 is arranged adjacent to the first point P1 of the cover 1010, the vehicle imaging device 100 may be implemented to entirely have a compact volume. The fourth point P4 of the mirror 1210 which is adjacent to the driver's seat may be arranged to be lower than the third point P3 on the Z-axis. The height h2 on the Z-axis between the fourth point P4 of the mirror 1210 and the second point P2 of the cover 1010 may be reduced compared to the height h1 on the Z-axis of FIG. 7A where the PGU is arranged below the cover.

Accordingly, the PGU 1100 may be arranged in a separated upper region in the vehicle other than an inner region of the dashboard 1001, and only the concave mirror 1210 may be arranged in the inner region of the dashboard 1001, thereby solving the issue due to the limited space of the dashboard 1001.

In some embodiments, a reflection effect and optical performance degradation, which may be caused by the cover 1010 of the dashboard 1001 due to the arrangement of the PGU 1100 in the separated region, may be overcome. To this end, a diffuser region 1130 in which a special optical element, namely, a diffractive optical element (DOE), may be arranged inside the PGU 1100.

To suppress reflection of light from the PGU 1100 by the cover 1010 of the dashboard and secure optical performance, the diffuser region 1130 to which DOEs, such as a micro lens array, are applied may be arranged. Accordingly, the diffuser region 1130 may diffract (refract) optical signal paths through a curved portion 1132, which includes DOEs on the substrate 1131, such that optical signals are applied toward the cover 1010 of the dashboard 1001. Reflection components by the cover 1010 of the dashboard may be absorbed through the curved portion 1132 which includes the DOEs, thereby absorbing unwanted reflection components of optical signals. The reflection components by the cover 1010 of the dashboard may also be absorbed through a Fresnel pattern 1120p which is formed on another surface of the second lens part 1120.

A polarizing film 1141 and a refractive film 1142 may be arranged on a reflection plane 1140 inside the PGU 1100. The polarizing film 1141 which is coated or linearly polarized may be applied to enable selective transmission/reflection of the reflection plane 1140. A holographic structure may be formed on another surface of a structure on which micro-lens elements are arranged. Accordingly, the reflection effect and optical performance degradation caused by the cover 1010 of the dashboard 1001 may be overcome.

The PGU 1100 may include an emission region 1101, a first lens part 1110, a second lens part 1120, a diffuser region 1130, and a display region 1150. The PGU 1100 may further include a reflection plane 1140.

Emission elements may be arranged in the emission region 1101. The emission elements arranged in the emission region 1101 may be light-emitting diodes (LEDs), but are not limited thereto, and may be implemented as arbitrary emission elements. The first lens part 1110 may be arranged spaced apart from the emission elements of the emission region 1101 in one axial direction, for example, in the Y-axis direction. The second lens part 1120 may be arranged spaced apart from the first lens part 1110 in the one axial direction, for example, in the Y-axis direction.

The first lens part 1110 may include first convex lenses which are formed convexly on one surface thereof facing the second lens part 1120 and arranged on an XZ plane. The second lens part 1120 may include second convex lenses which are formed convexly on one surface thereof facing the first lens part 1110 and arranged on the XZ plane. The second lens part 1120 may include a Fresnel pattern 1120p arranged on another surface thereof and having a plurality of concave elliptical curved surfaces.

Referring to (a) of FIG. 10, a cross-sectional view of the Fresnel pattern 1120p formed on the another surface of the second lens part 1120 is shown. Referring to (b) of FIG. 10, the Fresnel pattern 1120p formed on the another surface of the second lens part 1120 may have a certain depth Dp. The Fresnel pattern 1120p may include first patterns 1121 in first regions 1120R1 and second patterns 1122 in second regions 1120R1. The first patterns 1121 may be formed as metal patterns and configured to reflect light. The second patterns 1122 may be formed as metal patterns or non-metal patterns.

The first patterns 1121 and the second patterns 1122 of the Fresnel pattern 1120p may be formed repeatedly. The first patterns 1121 of the Fresnel pattern 1120p may be reduced to a first length L1a, a second length L1b, and a third length L3b based on a center portion. Accordingly, optical signals passing through the second lens part 1120 having the Fresnel pattern 1120p may be more concentrated on the center portion than on a peripheral portion. Accordingly, image quality in a central region, in which the image is displayed by the optical signals, corresponding to the center portion of the second lens part 1120 having the Fresnel pattern 1120p, may be more improved than image quality in a peripheral region.

Intersections between the first patterns 1121 and the second patterns 1122 of the Fresnel pattern 1120p may form a first ellipse 1121b on the XZ plane. The second patterns 1122 of the Fresnel pattern 1120p may form a second ellipse 1122b on the XZ plane where the another surface of the second lens part 1120 is formed. The area of the second ellipse 1122b by the second patterns 1122 of the Fresnel pattern 1120p may be wider than the area of the first ellipse 1121b by the first patterns 1121 of the Fresnel pattern 1120p.

The second pattern 1122 of the Fresnel pattern 1120p may be formed on the XY plane by connecting a first point on a long axis of the first ellipse 1121b of the Fresnel pattern 1120p and a second point on a long axis of the second ellipse 1122b. The second pattern 1122 of the Fresnel pattern 1120p may be tilted by a certain angle qs with respect to the Y axis. In a different configuration, when the first ellipse 1121b and the first ellipse 1121b of the Fresnel pattern 1120p are formed identically, the second pattern 1122 of the Fresnel pattern 1120p may be formed vertically as shown in (c) of FIG. 9.

Hereinafter, the PGU 1100 of the vehicle imaging device according to the specification will be described in detail with reference to FIG. 6B, and 7B to 11. A second height hc2 of the second convex lenses of the second lens part 1120 on the Y axis may be lower than a first height hc1 of the first convex lenses of the first lens part 1110 on the Y axis. A second diameter Dc2 of the second convex lenses of the second lens part 1120 on the X axis or Y axis may be smaller than a first diameter Dc1 of the first convex lenses of the first lens part 1110 on the Y axis. Accordingly, the second lens part 1120 including the second convex lenses having certain diameter and height less than a threshold value may form a micro lens array.

The diffuser region 1130 may be arranged axially spaced apart from the second lens part 1220 so as to change a proceeding direction of light, which has passed through the first lens part 1110 and the second lens part 1120. The display region 1150 may be arranged spaced apart from the diffuser region 1130 in the one axial direction so that light, which has passed through the diffuser region 1130 and changed in the proceeding direction, passes therethrough to form an image.

The display region 1150 may be implemented as a liquid crystal display (LCD) or digital light processing (DLP), but is not limited thereto, and may be implemented as any display structure other than an emission element. The display region 1150 may be arranged to be tilted by a certain tilt angle in the Z-axis direction with respect to the diffuser region 1130. The display region 1150 may be arranged to be tilted at a tilt angle smaller than 90 degrees with respect to a horizontal plane.

Light refracted (diffracted) through the diffuser region 1130 may pass through the display region 1150 and a cover plate 1350 to proceed toward the cover 1010 of the dashboard. The cover plate 1350 may be arranged perpendicularly to the refracted light so as to form a light generation region by maximally utilizing the surface of the cover plate 1350. The cover plate 1350 may be arranged to be tilted at a tilt angle greater than 90 degrees with respect to the horizontal plane. The cover plate 1350 may be formed of a material having a permittivity below a threshold value for low loss characteristics of optical signals.

The reflection plane 1140 may be arranged between the second lens part 1120 and the diffuser region 1130. The reflection plane 1140 may be configured to reflect a first polarization component of light. A second polarization component orthogonal to the first polarization component of light transmitted through the reflection plane 1140 may pass through the display region 1150.

The reflection plane 1140 may include a reflective polarizing film 1141 and a refractive film 1142. The reflective polarizing film 1141 may be configured to reflect the first polarization component of light. The refractive film 1142 may suppress light dispersion by refracting light which passes through the first lens part 1110 and the second lens part 1120. The refractive film 1142 may refract the paths of optical signals passing through the first lens part 1110 and the second lens part 1120, so that the optical signal paths coincide with one point. Accordingly, the refractive film 1142 may correct the chromatic aberration of the optical signals which pass through the first lens part 1110 and the second lens part 1120.

The diffuser region 1130 may include a substrate 1131 and a curved portion 1132 having DOEs which are arranged on one surface of the substrate 1131. A proceeding direction of light which has passed through the DOEs of the curved portion 1132 of the diffuser region 1130 may be tilted downward at a certain angle with respect to the horizontal plane. The diffuser region 1130 may further include a flat portion 1133 formed between the substrate 1131 and the curved portion 1132. The formation of the flat portion 1133 of the diffuser region 1130 may reduce loss due to a structural difference between the substrate 1131 and the curved portion 1132 of the DOEs.

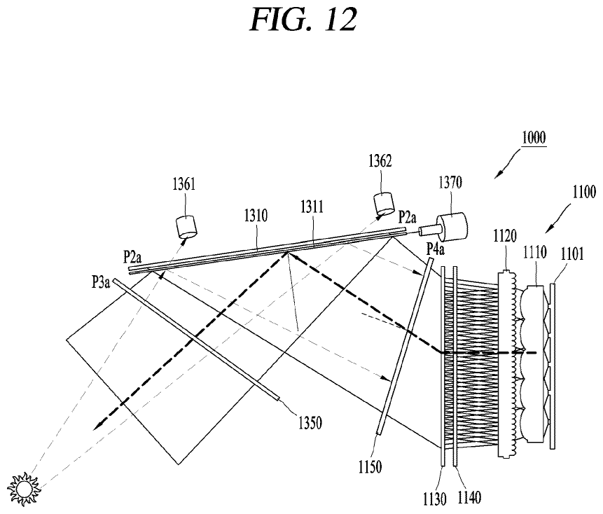

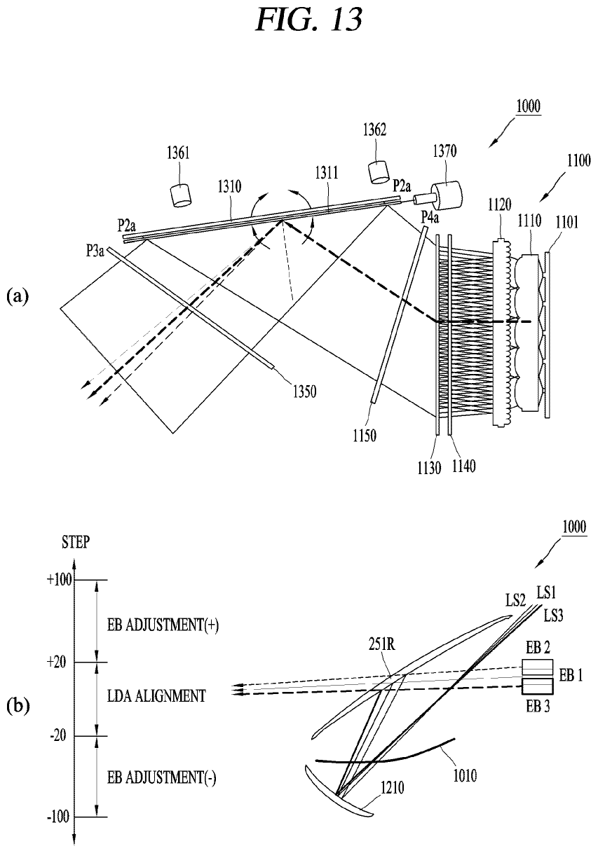

In some embodiments, the PGU of the vehicle imaging device according to the specification may be implemented to emit light and avoid sunlight. In this regard, FIG. 12 is a view of a first structure of a vehicle imaging device in which a first mirror is arranged substantially horizontally between a display region and cover glass. FIG. 13 is a diagram showing that a reflection angle is adjusted and an eyebox region is changed as the first mirror is tilted in the first structure of FIG. 12.

(a) of FIG. 13 illustrates optical signals LS1, LS2, and LS3 reflected from the first mirror 1310 when the first mirror 1310 is tilted in the first structure of the vehicle imaging device. (b) of FIG. 13 illustrates eyebox regions EB1, EB2, and EB3 according to the optical signals LS1, LS2, and LS3 emitted from the PGU 1100 of (a) of FIG. 13.

Referring to FIGS. 12 and 13, to secure the reliability of an LCD forming the display region 1150 from sunlight, infrared rays and specific polarization components which are not used by the LCD must be removed. A cold mirror structure shown in FIGS. 12 and 13 may be applied to remove infrared rays. The cold mirror structure shown in FIGS. 12 and 13 may be applied to reflect sunlight and infrared rays. A polarizing film 1311 may be arranged according to the optical characteristics of the LCD to reduce solar energy absorbed by the LCD forming the display region 1150. When the LCD forming the display region 1150 outputs S-waves, the polarizing film 1311 may have a pattern layer through which the S-waves are transmitted.

A front region of the first mirror 1310 may be a region where optical signals incident on the first mirror 1310 are reflected. Photo sensors 1361 and 1362 may be arranged in a rear region of the first mirror 1310, which is a cold mirror, to detect whether solar and infrared energy is incident and an amount of energy. Sunlight and P-waves of infrared rays may be reflected from the polarizing film 1311 of the first mirror 1310 and absorbed in the display region 1150. Sunlight and S-waves of infrared rays may pass through the first mirror 1310 on which the polarizing film 1311 is arranged and may be absorbed by the photo sensors 1361 and 1362. Therefore, the sunlight and S-waves of infrared rays may suppress interference with S-waves output from the display region 1150.

The optical signals LS1, LS2, and LS3 emitted from the PGU 1100 may pass through the cover 1010. The optical signals LS1, LS2, and LS3 which have passed through the cover 1010 may be reflected from the concave mirror 1210 and displayed in a specific region 251R of the windshield. The optical signals LS1, LS2, and LS3 displayed in the specific region 251R of the windshield may display images in the corresponding eyebox regions EB1, EB2, and EB3.

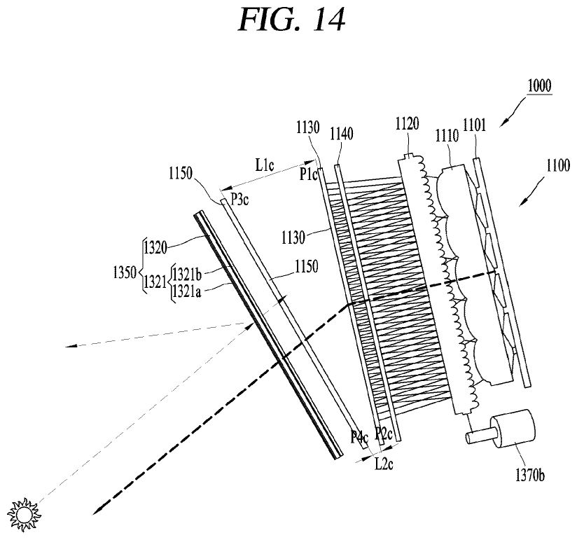

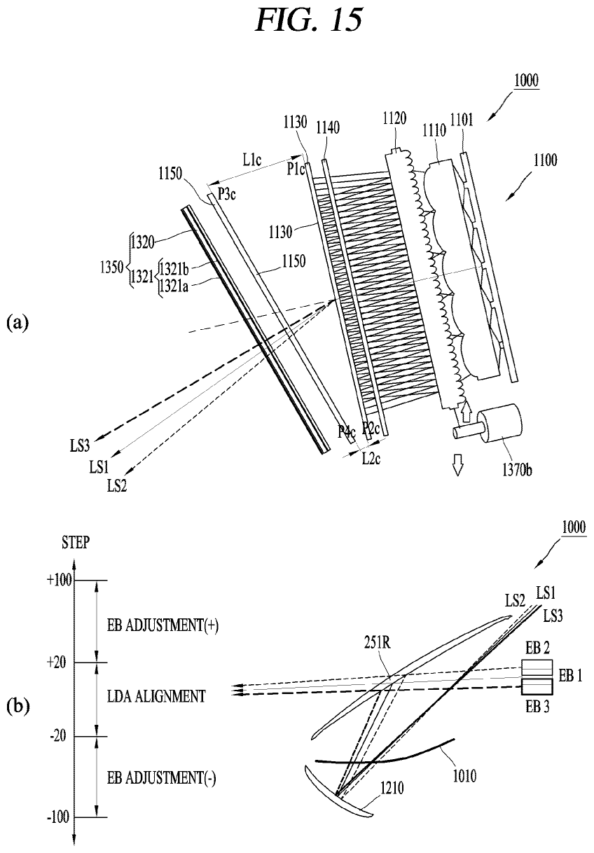

FIG. 14 is a diagram of a second structure of a vehicle imaging device in which a second mirror is arranged substantially parallel to the front of a display region. FIG. 15 is a diagram showing that a reflection angle is adjusted and an eyebox region is changed as the second mirror is tilted in the second structure of FIG. 14.

(a) of FIG. 15 illustrates optical signals LS1, LS2, and LS3 passing through the diffuser region 1130 and the cover glass 1350 while moving in the second lens part 1120 in the second structure of the vehicle imaging device. (b) of FIG. 15 illustrates eyebox regions EB1, EB2, and EB3 according to the optical signals LS1, LS2, and LS3 emitted from the PGU 1100 of (a) of FIG. 15.

Referring to FIGS. 14 and 15, to secure the reliability of an LCD forming the display region 1150 from sunlight, infrared rays and specific polarization components which are not used by the LCD must be removed. A hot mirror structure shown in FIGS. 14 and 15 may be applied to remove infrared rays. The hot mirror structure shown in FIGS. 14 and 15 may be applied to transmit sunlight and infrared rays. A second polarizing film 1321 may be arranged according to the optical characteristics of the LCD to reduce solar energy absorbed by the LCD forming the display region 1150. When the LCD forming the display region 1150 outputs S-waves, the second polarizing film 1321 may have a pattern layer by which the S-waves are reflected.

Sunlight and P-waves of infrared rays may pass through the second mirror 1320 on which the second polarizing film 1321 is arranged and may be absorbed by the display region 1150. Sunlight and S-waves of infrared rays may be reflected from the second mirror 1320 on which the second polarizing film 1321 is arranged so as not to proceed to the display region 1150. Therefore, the sunlight and S-waves of infrared rays may suppress interference with S-waves output from the display region 1150.

The optical signals LS1, LS2, and LS3 emitted from the PGU 1100 may pass through the cover 1010. The optical signals LS1, LS2, and LS3 which have passed through the cover 1010 may be reflected from the concave mirror 1210 and displayed in a specific region 251R of the windshield. The optical signals LS1, LS2, and LS3 displayed in the specific region 251R of the windshield may display images in the corresponding eyebox regions EB1, EB2, and EB3.

Referring to FIGS. 7B to 13, the vehicle imaging device 1000 may further include a first mirror 1310 and a cover glass 1350. The first mirror 1310 may be arranged above the PGU 1100 with being spaced apart from the PGU 1100. In another configuration, the first mirror 1310 may be arranged in the upper region of the structure of the PGU 1100 to be included in the PGU 1100.

The first mirror 1310 may be arranged parallel to the horizontal plane or at a tilt angle less than a threshold tilt angle to reflect light from the PGU 1100 and transmit sunlight. The cover glass 1350 may be arranged at a second tilt angle greater than 90 degrees such that light reflected from the first mirror 1310 passes through the cover glass 1350.

A first point P1a of the first mirror 1310 may be arranged adjacent to a third point P3a on an upper end of the cover glass 1350. A second point P2a of the first mirror 1310 may be arranged adjacent to a fourth point P4a at an upper end of the display region 1150. Light generated in the PGU 1100 may be reflected from the first mirror 1310 and pass through the cover glass 1350. Light which has passed through the cover glass 1350 may be reflected from the mirror 1310, may pass through the cover 1010, and may be reflected from the windshield 250, thus to be displayed as image information to the user in the vehicle.

In some embodiments, an upper end portion and a lower end portion of the diffuser region 1130 may form a first point P1c and a second point P2c. An upper end portion and a lower end portion of the display region 1150 may form a third point P3c and a fourth point P4c. The diffuser region 1130 may be arranged at a tilt angle of 90 degrees with respect to the horizontal plane, to be in parallel to the Y-axis.

A second distance L2c between the second point P2c of the diffuser region 1130 and the fourth point P4c of the display region 1150 may be longer than a first distance L1c between the first point P1c of the diffuser region 1130 and the third point P3c of the display region 1150. Therefore, the display region 1320b may be arranged at a first tilt angle which is smaller than 90 degrees with respect to the horizontal plane.

The first mirror 1310 may further include a polarizing film 1311. The polarizing film 1311 of the first mirror 1310 may be arranged on a front surface of the first mirror 1310. The polarizing film 1311 of the first mirror 1310 may be configured to transmit first polarization signals of sunlight and infrared rays and reflect a second polarization signal of light generated in the PGU 1100. The polarizing film 1311 of the first mirror 1310 may include patterns formed in a specific axial direction to transmit the first polarization signal and reflect the second polarization signal.

The vehicle imaging device 1000 may further include photo sensors 1361 and 1362. The photo sensors 1361 and 1362 may be arranged spaced apart from the first mirror 1310 in an upward direction of the first mirror 1310 on the Z-axis. The photo sensors 1361 and 1362 may be arranged at different points to detect sunlight and infrared rays transmitted through the first mirror 1310 and absorb the first polarization signals of the sunlight and infrared rays.

First and second positions of the photo sensors 1361 and 1362 may be determined based on a range of incident angles of a light-forming region of sunlight and infrared rays. A length of the first mirror 1310 may be longer than a distance between the first position and the second position of the photo sensors 1361 and 1362. Accordingly, the arrangement structure of the first mirror 1310 and the arrangement structure of the photo sensors 1361 and 1362 may be determined, so that all sunlight and infrared components within the light-forming region may be transmitted and sensed.

The first polarization signals of sunlight and infrared rays may be absorbed by the photo sensors 1361 and 1362 and thus may not be transmitted into the PGU 1100. The second polarization signals of sunlight and infrared rays may be reflected from the first mirror 1310 but absorbed in the display region 1150. Accordingly, all polarization components of sunlight and infrared rays may not be transmitted to the inner region of the PGU 1100.

The vehicle imaging device 1000 may further include a motor 1370 operably coupled to the first mirror 1310 to tilt the first mirror 1310 by a certain range of angles in the Z-axis direction. An incident angle of light which is emitted from the PGU 1100 and reflected from the surface of the first mirror 1310 may be adjusted by adjusting the tilt angle of the first mirror 1310 by the motor 1370. As the first mirror 1310 is tilted by the motor 1370, a refraction angle of light passing through the diffuser region 1130 may change. The change of the refraction angle of light passing through the diffuser region 1130 may allow for adjustment of the user's eyebox region on the Z axis.

Referring to FIGS. 7B to 10 and FIG. 12, the vehicle imaging device 1000 may further include a second mirror 1320 and a cover glass 1350. The second mirror 1320 may be arranged adjacent to the display region 1150. The second mirror 1320 may be arranged to be spaced apart in parallel from the display region 1150. The second mirror 1320 may be arranged below the PGU 1100 with being spaced apart from the PGU 1100. In another configuration, the second mirror 1320 may be arranged in one side region of the structure of the PGU 1100 to be included in the PGU 1100.

The display region 1150 may be arranged at a second tilt angle which is greater than 90 degrees with respect to the horizontal plane. The second mirror 1320 may be arranged to transmit light from the PGU 1100 and reflect sunlight. The second mirror 1320 may include a second polarizing film 1321. The second mirror 1320 having the second polarizing film 1321 disposed thereon may form the cover glass 1350.

The first point P1b of the second mirror 1320 may be arranged to be lower than the third point P3b on the upper end of the diffuser region 1130. The second point P2b of the second mirror 1320 may be arranged to be lower than the fourth point P4a on the lower end of the diffuser region 1130. Accordingly, light refracted (diffracted) downward in the diffuser region 1130 may pass through the display region 1150 and the cover glass 1350 arranged in the lower region, and pass through the cover 1010 in the downward direction to proceed into the dashboard. Light generated in the PGU 1100 may pass through the second mirror 1320 and the cover glass 1350. Light which has passed through the cover glass 1350 may be reflected from the mirror 1310, may pass through the cover 1010, and may be reflected from the windshield 250, thus to be displayed as image information to the user in the vehicle.

The second polarizing film 1321 may include second patterns which are arranged in a specific axial direction on one surface of the second mirror 1320 to reflect the first polarization signals of sunlight and infrared rays and to transmit the second polarization signal of light generated in the PGU 1100.

The mirror 1310 of FIG. 11 may transmit the first polarization components of sunlight and infrared rays, while the second mirror 1320 may reflect the first polarization signals of the sunlight and infrared rays. The second patterns of the second polarizing film 1321 may be different from the patterns formed on the polarizing film 1311 of FIG. 11. The second patterns of the second polarizing film 1321 may be orthogonal to the patterns formed on the polarizing film 1311 of FIG. 11.

Second polarizing films 1321a and 1321b may be arranged on one surface and another surface of the second mirror 1320. The second polarizing film 1321a arranged on the one surface of the second mirror 1320 may include second patterns formed to reflect the first polarization signals of sunlight and infrared rays. The second polarizing film 1321b arranged on the another surface of the second mirror 1320 may include second patterns formed to transmit the second polarization signals of the sunlight and infrared rays.

The second polarization signal of light generated in the PGU 1100 may transmit the second pattern of the second polarizing film 1321b arranged on the another surface of the second mirror 1320. The second polarization signal of light generated in the PGU 1100 may transmit the second pattern of the second polarizing film 1321a arranged on the one surface of the second mirror 1320.

In some embodiments, an upper end portion and a lower end portion of the diffuser region 1130 may form a first point P1c and a second point P2c. An upper end portion and a lower end portion of the display region 1150 may form a third point P3c and a fourth point P4c. The diffuser region 1130 may be arranged at a first tilt angle which is greater than 90 degrees with respect to the horizontal plane to be in parallel to the Y axis. The display region 1150 may be arranged at a second tilt angle which is greater than the first tilt angle.

A second distance L2c between the second point P2c of the diffuser region 1130 and the fourth point P4c of the display region 1150 may be shorter than a first distance L1c between the first point P1c of the diffuser region 1130 and the third point P3c of the display region 1150. Therefore, the display region 1150 may be arranged at the second tilt angle which is greater than the first tilt angle.

The vehicle imaging device 1000 may further include a second motor 1370b operably coupled to the second lens part 1120 to move the second lens part 1120 in the Z-axis direction. As the second lens part 1120 is moved by the second motor 1370b, the incident angle of light emitted from the PGU 1100 may be adjusted. As the second lens part 1120 is moved by the second motor 1370b, a refraction angle of light passing through the diffuser region 1130 may change, so that the user's eyebox region may be adjusted on the Z axis.

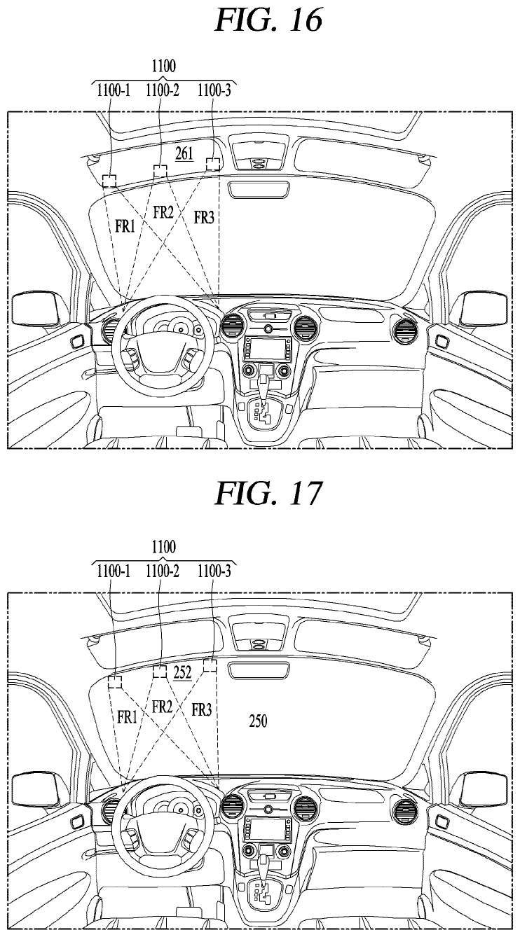

In some embodiments, at least one PGU 1100 of the vehicle imaging device according to the specification may be arranged at various locations in the vehicle. In this regard, FIGS. 16 to 19 are diagrams of vehicle arrangement structures each having at least one PGU at various locations in the vehicle according to embodiments.

Referring to FIGS. 6B, 7B, and 16 to 19, an HUD including the vehicle imaging device may include a PGU 1100, a virtual optical system, and a windshield 250. The PGU 1100 may be assembled to a lower end of the virtual optical system to be fixed inside the dashboard 10 of the vehicle. In the interior of the dashboard 1001 may be arranged a pedal device, an air conditioning device, and various electrical components, so a space for the HUD may be limited.

The PGU 1100 may be attached to a roof region, pillar region, and upper region of the windshield of the vehicle, other than the dashboard, thereby overcoming a spatial limitation for an HUD. When an image generated by optical signals generated in the PGU 1100 is output to the concave mirror 1210 arranged inside the dashboard 1001, invalid light may be diffusely reflected from the cover 1010 which is the surface of the dashboard 1001. Light which is diffusely reflected from the cover 1010 may affect image quality and may be an issue in this PGU-separated structure. The diffuse reflection may be avoided by applying the diffuser region 1130 implemented as a shaped diffuser having a surface to suppress invalid light from being emitted to the cover 1010, which is the surface of the dashboard 1001. In some embodiments, by varying the shapes of the surfaces of the shaped diffuser, the tilt angle of the light-forming region of light generated in the PGU 1100 may be controlled.

Referring to FIG. 16, the PGU 1100 may be arranged as a plurality of PGUs in a roof region 261 inside the vehicle to be coupled to the windshield 250 above the windshield 250 of the vehicle. The PGU 1100 may include a first PGU 1100-1, a second PGU 1100-2, and a third PGU 1100-3 spaced apart in the horizontal axis direction in the roof region 261. The number of PGUs 1100 is not limited to three and may change depending on the applications, such as an image information display region where image information by optical signals is displayed in the vehicle, the number of displayed images, and an arrangement structure of the displayed images.

The first PGU 1100-1, the second PGU 1100-2, and the third PGU 1100-3 may form a first light-forming region FR1, a second light-forming region FR2, and a third light-forming region FR3, respectively. The second light-forming region FR2 by the second PGU 1100-2 may be formed in a certain angle range based on 0 degree. The first light-forming region FR1 by the first PGU 1100-1 may be formed in a right direction toward the second light-forming region FR2. The third light-forming region FR3 by the third PGU 1100-3 may be formed in a left direction toward the second light-forming region FR2.

Referring to FIG. 17, the PGU 1100 may be arranged as a plurality of PGUs in the upper region 252 of the windshield 250 of the vehicle. The PGU 1100 may include a first PGU 1100-1, a second PGU 1100-2, and a third PGU 1100-3 spaced apart in the horizontal axis direction in the roof region 252. The number of PGUs 1100 is not limited to three and may change depending on the applications, such as an image information display region where image information by optical signals is displayed in the vehicle, the number of displayed images, and an arrangement structure of the displayed images.

The first PGU 1100-1, the second PGU 1100-2, and the third PGU 1100-3 may form a first light-forming region FR1, a second light-forming region FR2, and a third light-forming region FR3, respectively. The second light-forming region FR2 by the second PGU 1100-2 may be formed in a certain angle range based on 0 degree. The first light-forming region FR1 by the first PGU 1100-1 may be formed in a right direction toward the second light-forming region FR2. The third light-forming region FR3 by the third PGU 1100-3 may be formed in a left direction toward the second light-forming region FR2.

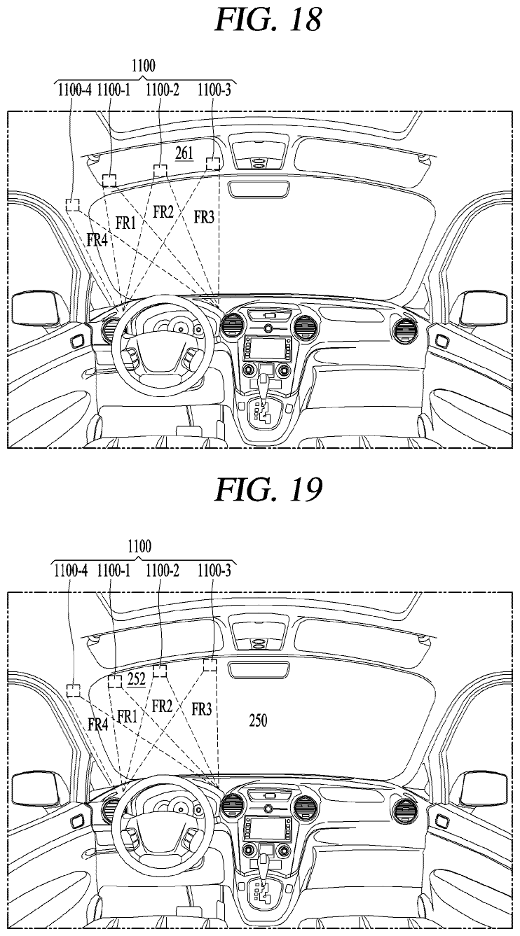

Referring to FIG. 18, the PGU 1100 may be arranged as a plurality of PGUs in the roof region 261 and a pillar region 262 of the vehicle. The PGUs 1100 which are coupled in the vehicle to the windshield 250 on an upper portion of the windshield 250 may include a first PGU 1100-1, a second PGU 1100-2, and a third PGU 1100-3 arranged in the horizontal axial direction in the roof region 261. The PGU 1100 may further include a fourth PGU 1100-4 which is arranged in the pillar region 262 inside the vehicle and coupled to the windshield 250 on one side of the windshield 250. The fourth PGU 1100-4 may be arranged in a lower region on the Z-axis, compared to the first PGU 1100-1, and may display an image different from an image of the first PGU 1100-1 in an overlapping manner.

The number of PGUs 1100 is not limited to four and may change depending on the applications, such as an image information display region where image information by optical signals is displayed in the vehicle, the number of displayed images, and an arrangement structure of the displayed images.

The first PGU 1100-1, the second PGU 1100-2, the third PGU 1100-3, and the fourth PGU 1100-4 may form a first light-forming region FR1, a second light-forming region FR2, a third light-forming region FR3, and a fourth light-forming region FR4, respectively. The second light-forming region FR2 by the second PGU 1100-2 may be formed in a certain angle range based on 0 degree. The first light-forming region FR1 by the first PGU 1100-1 may be formed in a right direction toward the second light-forming region FR2. The third light-forming region FR3 by the third PGU 1100-3 may be formed in a left direction toward the second light-forming region FR2. The fourth light-forming region FR4 by the fourth PGU 1100-4 may be formed in a right direction toward the second light-forming region FR2. A second tilt angle at which the fourth light-forming region FR4 by the fourth PGU 1100-4 is tilted may be greater than a first tilt angle at which the first light-forming region FR1 by the first PGU 1100-1 is tilted.

Referring to FIG. 19, the PGU 1100 may be arranged as a plurality of PGUs in the roof region 261 and a pillar region 262 of the vehicle. The PGUs 1100 which are coupled in the vehicle to the windshield 250 on an upper portion of the windshield 250 may include a first PGU 1100-1, a second PGU 1100-2, and a third PGU 1100-3 arranged in the horizontal axial direction in the roof region 261. The PGU 1100 may further include a fourth PGU 1100-4 which is arranged in the pillar region 262 inside the vehicle and coupled to the windshield 250 on one side of the windshield 250. The fourth PGU 1100-4 may be arranged at substantially the same height as the first PGU 1100-1 on the Z-axis. Accordingly, when image quality by the first PGU 1100-1 is lowered, an image may be displayed by the fourth PGU 1100-4.

The number of PGUs 1100 is not limited to four and may change depending on the applications, such as an image information display region where image information by optical signals is displayed in the vehicle, the number of displayed images, and an arrangement structure of the displayed images.

The first PGU 1100-1, the second PGU 1100-2, the third PGU 1100-3, and the fourth PGU 1100-4 may form a first light-forming region FR1, a second light-forming region FR2, a third light-forming region FR3, and a fourth light-forming region FR4, respectively. The second light-forming region FR2 by the second PGU 1100-2 may be formed in a certain angle range based on 0 degree. The first light-forming region FR1 by the first PGU 1100-1 may be formed in a right direction toward the second light-forming region FR2. The third light-forming region FR3 by the third PGU 1100-3 may be formed in a left direction toward the second light-forming region FR2. The fourth light-forming region FR4 by the fourth PGU 1100-4 may be formed in a right direction toward the second light-forming region FR2. A second tilt angle at which the fourth light-forming region FR4 by the fourth PGU 1100-4 is tilted may be greater than a first tilt angle at which the first light-forming region FR1 by the first PGU 1100-1 is tilted.

Referring to FIGS. 6A and 16 to 19, a first image including vehicle-related information may be displayed in a first image region IR1, which is closest to the FOV of the driver of vehicle, through the first light-forming region FR1 of the first PGU 1100-1. A second image related to a driving path of the vehicle may be displayed in a second image region IR2 through the second light-forming region FR2 of the second PGU 1100-2. A third image related to a map, which includes a departure and a destination, may be displayed in a third image region IR3 through the third light-forming region FR3 of the third PGU 1100-3.

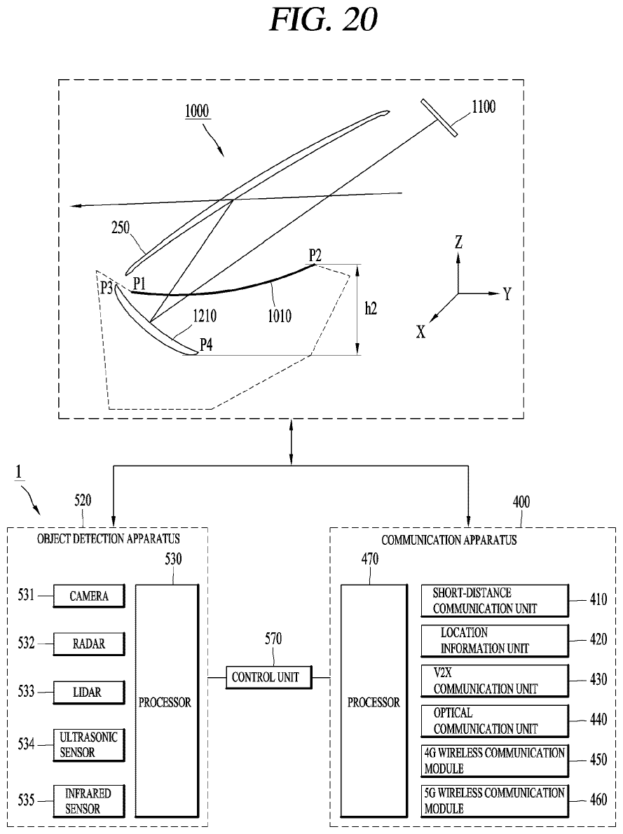

The foregoing description has been given of the vehicle imaging devices 1000 according to one aspect of the present disclosure. Hereinafter, a vehicle including the vehicle imaging device 1000 according to another aspect of the specification will be described. All descriptions of the vehicle imaging devices 1000 and 1000b of FIGS. 6A to 14 described above and the vehicle 1 of FIGS. 1 to 5 may be applied to a vehicle including a vehicle imaging device 1000 below. In some embodiments, FIG. 20 is a block diagram of a vehicle having a vehicle imaging device according to the disclosure.

Hereinafter, a vehicle 1 having the vehicle imaging device 1000 according to the specification will be described, with reference to FIGS. 1 to 20. The vehicle 1 may include a windshield 250, a dashboard 1001, and a vehicle imaging device 1000. The vehicle imaging device 1000 may perform wireless communication with an entity outside the vehicle 1 by linking with the communication device 400 of the vehicle 1. The vehicle imaging device 1000 may be configured to detect information related to objects outside the vehicle 1 and the speed, status, and specifications of the vehicle 1 in conjunction with the object detection device 520 of the vehicle 1.

The vehicle imaging device 1000 may display, in the first image region IR1 of FIG. 6A, information related to the speed, status, and specifications of an object or vehicle detected through the object detection device 520. The vehicle imaging device 1000 may display, in the second image region IR2, information related to the driving path of the vehicle using surrounding traffic information received through the communication device 400.

The vehicle imaging device 1000 may include a cover 1010, a PGU 1100, and a mirror 1210. The windshield 250 may be arranged on a front surface of the vehicle 1. The vehicle imaging device 1000, 1000b may be arranged inside the dashboard 250 of the vehicle 1 and between the windshield 250 and the dashboard 1001.

The cover 1010 may form the appearance of the dashboard 1001 of the vehicle. The dashboard 1001 may include a first region 1001a in which a lower region of the vehicle imaging device 1000 is arranged, and a second region 1001b in which other components and mechanical devices are arranged. The PGU 1100 may be arranged in the upper region of the cover 1010 in the Z-axis direction. The mirror 1210 arranged in the lower region of the cover 1010 may be arranged in the first region 1001a of the dashboard 1001.

The PGU 1100 may emit light downward so that the light passes through the cover 1010. The mirror 1210 may be arranged in the cover 1010 which defines the appearance of the dashboard 1001. The mirror 1210 may be configured to reflect light which has passed through the cover 1010. The cover 1010 may have a cross-section which is formed as a curve connecting a first point P1 and a second point P2. The second point P2 of the cover 1010 may be arranged to be higher than the first point P1 on the Z axis. The mirror 1210 may be configured as a concave mirror 1210 whose cross-section is formed as a curve connecting a third point P3 and a fourth point P4.

The first point P1 of the cover 1010 may be arranged adjacent to a lower end portion on the windshield 250. The second point P2 of the cover 1010 may be arranged more adjacent to a driver's seat than the lower end portion of the windshield 250. The mirror 1210 may be arranged such that the third point P3 is more adjacent to the first point P1 of the cover 1010 than to the second point P2. As the third point P3 of the mirror 1210 is arranged adjacent to the first point P1 of the cover 1010, the vehicle imaging device 100 may be implemented to entirely have a compact volume. The fourth point P4 of the mirror 1210 which is adjacent to the driver's seat may be arranged to be lower than the third point P3 on the Z-axis. The height h2 on the Z-axis between the fourth point P4 of the mirror 1210 and the second point P2 of the cover 1010 may be reduced compared to the height h1 on the Z-axis of FIG. 7A where the PGU is arranged below the cover.

The PGU 1100 may include an emission region 1101, a first lens part 1110, a second lens part 1120, a diffuser region 1130, and a display region 1150. The PGU 1100 may further include a reflection plane 1140.

Emission elements may be arranged in the emission region 1101. The emission elements arranged in the emission region 1101 may be light-emitting diodes (LEDs), but are not limited thereto, and may be implemented as arbitrary emission elements. The first lens part 1110 may be arranged spaced apart from the emission elements of the emission region 1101 in one axial direction, for example, in the Y-axis direction. The second lens part 1120 may be arranged spaced apart from the first lens part 1110 in the one axial direction, for example, in the Y-axis direction.

The first lens part 1110 may include first convex lenses which are formed convexly on one surface thereof facing the second lens part 1120 and arranged on an XZ plane. The second lens part 1120 may include second convex lenses which are formed convexly on one surface thereof facing the first lens part 1110 and arranged on the XZ plane. The second lens part 1120 may include a Fresnel pattern 1120p arranged on another surface thereof and having a plurality of concave elliptical curved surfaces.

A second height hc2 of the second convex lenses of the second lens part 1120 on the Y axis may be lower than a first height hc1 of the first convex lenses of the first lens part 1110 on the Y axis. A second diameter Dc2 of the second convex lenses of the second lens part 1120 on the X axis or Y axis may be smaller than a first diameter Dc1 of the first convex lenses of the first lens part 1110 on the Y axis. Accordingly, the second lens part 1120 including the second convex lenses having certain diameter and height less than a threshold value may form a micro-lens array.

The diffuser region 1130 may be arranged axially spaced apart from the second lens part 1220 so as to change a proceeding direction of light, which has passed through the first lens part 1110 and the second lens part 1120. The display region 1150 may be arranged spaced apart from the diffuser region 1130 in the one axial direction so that light, which has passed through the diffuser region 1130 and changed in the proceeding direction, passes therethrough to form an image.

The display region 1150 may be implemented as an LCD, but is not limited thereto, and may be implemented as any display structure other than an emission element. The display region 1150 may be arranged to be tilted by a certain tilt angle in the Z-axis direction with respect to the diffuser region 1130. The display region 1150 may be arranged to be tilted at a tilt angle smaller than 90 degrees with respect to a horizontal plane.

Light refracted (diffracted) through the diffuser region 1130 may pass through the display region 1150 and a cover plate 1350 to proceed toward the cover 1010 of the dashboard. The cover plate 1350 may be arranged perpendicularly to the refracted light so as to form a light generation region by maximally utilizing the surface of the cover plate 1350. The cover plate 1350 may be arranged to be tilted at a tilt angle greater than 90 degrees with respect to the horizontal plane. The cover plate 1350 may be formed of a material having a permittivity below a threshold value for low loss characteristics of optical signals.

The reflection plane 1140 may be arranged between the second lens part 1120 and the diffuser region 1130. The reflection plane 1140 may be configured to reflect a first polarization component of light. A second polarization component orthogonal to the first polarization component of light transmitted through the reflection plane 1140 may pass through the display region 1150.

The reflection plane 1140 may include a reflective polarizing film 1141 and a refractive film 1142. The reflective polarizing film 1141 may be configured to reflect the first polarization component of light. The refractive film 1142 may suppress light dispersion by refracting light which passes through the first lens part 1110 and the second lens part 1120. The refractive film 1142 may refract the paths of optical signals passing through the first lens part 1110 and the second lens part 1120, so that the optical signal paths coincide with one point. Accordingly, the refractive film 1142 may correct the chromatic aberration of the optical signals which pass through the first lens part 1110 and the second lens part 1120.

The diffuser region 1130 may include a substrate 1131, and a curved portion 1132 having DOEs which are arranged on one surface of the substrate 1131. A proceeding direction of light which has passed through the DOEs of the curved portion 1132 of the diffuser region 1130 may be tilted downward at a certain angle with respect to the horizontal plane. The diffuser region 1130 may further include a flat portion 1133 formed between the substrate 1131 and the curved portion 1132. The formation of the flat portion 1133 of the diffuser region 1130 may reduce loss due to a structural difference between the substrate 1131 and the curved portion 1132 of the DOEs.

So far, a vehicle imaging device with a reduced volume according to the specification has been described. The technical effects of the vehicle imaging device with the reduced volume according to the specification may be summarized as follows, but are not limited thereto.

According to the specification, a vehicle imaging device may be provided in which a picture generation unit (PGU)-separated structure is implemented and a volume of the vehicle imaging device is reduced by arranging the PGU in a separated upper region in a vehicle, other than an inner region of a dashboard.

According to the specification, a limited space issue of the dashboard may be resolved by arranging only a concave mirror in an inner region of the dashboard and arranging the PGU in a separated upper region inside the vehicle, other than the inner region of the dashboard.

According to the specification, a reflection effect and optical performance degradation, which may be caused by a cover of the dashboard due to the arrangement of the PGU in the separated region, may be overcome.

According to the specification, a diffuser region in which a special optical element, namely, a diffractive optical element (DOE), is arranged inside the PGU 1100 may be formed to overcome the reflection effect and optical performance degradation caused by the cover of the dashboard.

According to the specification, a polarizing film and a refractive film may be arranged on a reflection plane inside the PGU so as to overcome the reflection effect and optical performance degradation caused by the cover of the dashboard.

According to the specification, a holographic structure may be formed on another surface of a structure in which lens elements are arranged inside the PGU, thereby overcoming the reflection effect and optical performance degradation caused by the cover of the dashboard.

According to the specification, a vehicle imaging device having a PGU-separated structure may be provided to secure optical performance while allowing volume reduction, by proposing a new optical structure which is capable of securing optical performance and avoiding side effects.

According to the specification, a structure may be provided in which the PGU is separately mounted to a ceiling, windshield, or A-pillar structure to enable volume reduction.

The effects of the disclosure are not limited to those effects mentioned above, and other effects not mentioned may be clearly understood by those skilled in the art from the description of the appended claims.

The disclosure may be implemented as computer-readable codes in a program-recorded medium. The computer-readable medium may include all types of recording devices each storing data readable by a computer system. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like. Also, the computer may include a processor or a controller. Therefore, the detailed description should not be limitedly construed in all of the aspects, and should be understood to be illustrative. The scope of the present disclosure should be determined by reasonable interpretation of the appended claims, and all changes within the equivalent scope of the present disclosure are embraced by the appended claims.

1. A vehicle imaging device comprising:
a cover forming appearance of a dashboard of a vehicle;
a picture generation unit (PGU) arranged in an upper region of the cover, and configured to emit light in a downward direction such that the light passes through the cover; and
a mirror arranged inside the dashboard, and configured to reflect the light passing through the cover.

2. The vehicle imaging device of claim 1, wherein
a cross-section of the cover is formed as a curve connecting a first point and a second point, the second point being arranged higher than the first point on a Z-axis, and
the mirror is configured as a concave mirror with a cross-section which is formed as a curve connecting a third point and a fourth point.

3. The vehicle imaging device of claim 2, wherein
the first point is arranged adjacent to a lower end portion on a windshield, and the second point is arranged more adjacent to a driver's seat than to the lower end portion on the windshield, and
the third point is arranged adjacent to the first point, and the fourth point, which is arranged adjacent to the driver's seat, is arranged lower than the third point on the Z-axis.

4. The vehicle imaging device of claim 1, wherein
the PGU comprises:
an emission region in which emission elements are arranged;
a first lens part arranged spaced apart from the emission elements in one axial direction;
a second lens part arranged spaced apart from the first lens part in the one axial direction;
a diffuser region arranged spaced apart from the second lens part in the one axial direction, to change a proceeding direction of the light passing through the first lens part and the second lens part; and
a display region arranged spaced apart from the diffuser region in the one axial direction, so that the light, which has changed in the proceeding direction by passing through the diffuser region, passes through the display region and forms an image.

5. The vehicle imaging device of claim 4, wherein
the first lens part comprises first convex lenses formed convexly on one surface thereof facing the second lens part, and arranged on an XZ plane, and
the second lens part comprises second convex lenses formed convexly on one surface thereof facing the first lens part, and arranged on the XZ plane, and.

6. The vehicle imaging device of claim 5, wherein
the second lens part comprises a Fresnel pattern formed on another surface thereof and having a plurality of concave elliptical curved surfaces,
a second height on a Y-axis of the second convex lenses is lower than a first height on the Y-axis of the first convex lenses, and
a second diameter on an X-axis or Y-axis of each of the second convex lenses is smaller than a first diameter on the Y-axis of each of the first convex lenses.

7. The vehicle imaging device of claim 4, wherein
the PGU further comprises:
a reflection plane arranged between the second lens part and the diffuser region, and configured to reflect a first polarization component of the light, and
a second polarization component orthogonal to the first polarization component of the light transmitted through the reflection plane passes through the display region.

8. The vehicle imaging device of claim 7, wherein
the reflection plane comprises a reflective polarizing film configured to reflect the first polarization component of the light and a refractive film configured to refract the light passing through the first lens part and the second lens part to suppress light dispersion,
the diffuser region comprises a substrate and diffractive optical elements (DOE) arranged on one surface of the substrate, and
a proceeding direction of the light passing through the DOEs is formed at a certain tilt angle in a downward direction with respect to a horizontal plane.

9. The vehicle imaging device of claim 4, wherein
the display region is arranged at a first tilt angle smaller than 90 degrees with respect to a horizontal plane,
the vehicle imaging device further comprises: a first mirror arranged above the PGU with being spaced apart from the PGU, and configured to reflect the light from the PGU and transmit sunlight; and
a cover glass arranged at a second tilt angle greater than 90 degrees to allow the light reflected from the first mirror to pass therethrough.

10. The vehicle imaging device of claim 2, wherein
a first point of the first mirror is arranged adjacent to a third point on an upper end of the cover glass, and a second point of the first mirror is arranged adjacent to a fourth point on an upper end of the display region, and
the light generated in the PGU is reflected from the first mirror, passes through the cover glass, is reflected from the mirror, passes through the cover, and is reflected from a windshield, so as to be displayed as image information to a user inside the vehicle.

11. The vehicle imaging device of claim 9, wherein
upper and lower end portions of the diffuser region form a first point and a second point,
upper and lower end portions of the display region form a third point and a fourth point,
the diffuser region is arranged at a tilt angle of 90 degrees, and
the display region is arranged at a first tilt angle smaller than 90 degrees, so that a second distance between the second point and the fourth point is longer than a first distance between the first point and the third point.

12. The vehicle imaging device of claim 10, wherein
the first mirror comprises a polarizing film arranged on a front surface thereof and having patterns formed in a specific axial direction to transmit first polarization signals of the sunlight and ultraviolet rays and reflect a second polarization signal of the light generated in the PGU.

13. The vehicle imaging device of claim 12, further comprising:
photo sensors arranged spaced apart from the first mirror above the first mirror on a Z-axis; and
a motor coupled to the first mirror to tilt the first mirror in the Z-axis direction at an angle in a certain range,
wherein the photo sensors are arranged at different points to detect the sunlight and ultraviolet rays transmitted through the first mirror and absorb first polarization signals of the sunlight and the ultraviolet rays, and
a refraction angle of the light passing through the diffuser region is changed as the first mirror is tilted by the motor, so that the user's eyebox region is adjusted on the Z-axis.

14. The vehicle imaging device of claim 4, wherein
the diffuser region is arranged at a second tilt angle greater than 90 degrees with respect to a horizontal plane, and
the vehicle imaging device comprises a second mirror arranged adjacent to the display region and configured to transmit the light from the PGU and reflect sunlight,
the second mirror on which a second polarizing film is arranged forms a cover glass, and
the light generated in the PGU passes through the second mirror and the cover glass, is reflected from the mirror, passes through the cover again, and is reflected from a windshield, so as to be displayed as image information to a user inside the vehicle.

15. The vehicle imaging device of claim 14, wherein
the second mirror comprises the second polarizing film arranged on one surface thereof and having second patterns formed in a specific axial direction to reflect first polarization signals of the sunlight and ultraviolet rays and transmit a second polarization signal of the light generated in the PGU.

16. The vehicle imaging device of claim 14, wherein
upper and lower end portions of the diffuser region form a first point and a second point,
upper and lower end portions of the display region form a third point and a fourth point,
the diffuser region is arranged at a first tilt angle greater than 90 degrees,
the display region is arranged at a second tilt angle greater than the first tilt angle, and
the display region is arranged at the second tilt angle greater than the first tilt angle, so that a second distance between the second point and the fourth point is shorter than a first distance between the first point and the third point.

17. The vehicle imaging device of claim 14, further comprising
a second motor coupled to the second lens part to move the second lens part in a Z-axis direction,
wherein a refraction angle of the light passing through the diffuser region is changed as the second lens part is moved by the second motor, so that the user's eyebox region is adjusted on the Z-axis.

18. The vehicle imaging device of claim 1, wherein
the PGU is arranged as a plurality of PGUs in a roof region inside the vehicle, coupled to the windshield above a windshield,
the PGUs comprise a first PGU, a second PGU, and a third PGU spaced apart in a horizontal axis direction in the roof region,
the first PGU, the second PGU, and the third PGU form a first light-forming region, a second light-forming region, and a third light-forming region, respectively, and
the second light-forming region is formed in a certain angular range with respect to 0 degree, the first light-forming region is formed in a right direction toward the second light-forming region, and the third light-forming region is formed in a left direction toward the second light-forming region.

19. The vehicle imaging device of claim 1, wherein
the PGU is arranged as a plurality of PGUs in an upper region of a windshield,
the PGUs comprise a first PGU, a second PGU, and a third PGU spaced apart in a horizontal axis direction in the upper region of the windshield,
the first PGU, the second PGU, and the third PGU form a first light-forming region, a second light-forming region, and a third light-forming region, respectively, and
the second light-forming region is formed in a certain angular range with respect to 0 degree, the first light-forming region is formed in a right direction toward the second light-forming region, and the third light-forming region is formed in a left direction toward the second light-forming region.

20. The vehicle imaging device of claim 18, wherein
the PGU further comprises a fourth PGU arranged in a pillar region inside the vehicle, coupled to the windshield on one side of the windshield,
a fourth light-forming region of the fourth PGU is formed in a right direction toward the second light-forming region, and
a second tilt angle at which the fourth light-forming region is tilted is greater than a first tilt angle at which the first light-forming region is tilted.
